(19) United States
(12) Patent Application Publication
(10) Pub. No.: US 2026/0358972 A1
(43) Pub. Date: Nov. 12, 2026

(54) Heterogeneous Memory Module with Intelligent Page Migration based on Reinforcement Learning

(71) Applicant: Micron Technology, Inc., Boise, ID (US)

(72) Inventor: Poorna Kale, Folsom, CA (US)

(21) Appl. No.: 19/201,804

(22) Filed: May 7, 2025

(51) Int. Cl. G06F 3/06

(52) U.S. Cl. CPC G06F 3/0647; G06F 3/061; G06F 3/0685

(57) ABSTRACT

A memory sub-system including: at least one first memory chip having memory cells of a first type (e.g., flash memory); at least one second memory chip having memory cells of a second type (e.g., dynamic random access memory (DRAM) or static random access memory (SRAM)); a reinforcement learning module; and a page migration engine. The reinforcement learning module is configured to identify, based on a reward model, memory pages for migration between the at least one first memory chip and the at least one second memory chip; and the page migration engine is configured to implement migration of the memory pages identified by the reinforcement learning module.

### TECHNICAL FIELD

At least some embodiments disclosed herein relate to memory systems in general and, more particularly but not limited to, memory systems having memories of different characteristics.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a host system and a memory sub-system configured in accordance with some embodiments of the present disclosure.

FIG. 2 shows a memory sub-system having a page migration engine configured according to one embodiment.

FIG. 3 shows an example of memory sub-systems having a page migration engine configured according to one embodiment.

FIG. 4 shows a buffer chip configured with a page migration queue according to one embodiment.

FIG. 5 illustrates a page migration queue according to one embodiment.

FIG. 6 shows a method of autonomous page migration within a heterogeneous memory sub-system according to one embodiment.

FIG. 7 shows a memory sub-system having a reinforcement learning module configured to identify pages for migration according to one embodiment.

FIG. 8 shows an example of memory sub-systems having a reinforcement learning module and a page migration engine configured according to one embodiment.

FIG. 9 shows a buffer chip configured with a reinforcement learning module having a reward model to identify memory pages for migration according to one embodiment.

FIG. 10 illustrates a technique to identify pages for migration using a reinforcement learning module according to one embodiment.

FIG. 11 shows a method of page migration within a heterogeneous memory sub-system according to one embodiment.

FIG. 12 is a block diagram of an example computer system in which embodiments of the present disclosure can operate.

### DETAILED DESCRIPTION

Different types of memories can have different trade-offs in performance, cost, capacity, power consumption, endurance, etc. For example, NAND flash memory is non-volatile in that it can retain data without being connected to a power supplier; and dynamic random access memory (DRAM) is volatile in that data stored in it can be corrupted or lost if a power supplier is disconnected from it for a short period (e.g., during a power outage event). NAND flash memory is less expensive than DRAM in offering a large capacity and thus is typically used in solid-state drives as storage media. DRAM can have an access speed, and endurance, much higher than NAND flash memory and thus is typically used as the main memory of a computer system.

When the demand for memory resources from the main memory exceeds its capacity in a computer system, the operating system of the computer system can swap some of the memory pages in the main memory to a storage device, such as a solid-state drive. For example, data in a memory page that is not in active use can be stored into the storage device to swap the memory page out of the main memory into the storage device; and the state of the memory page is preserved in the storage device such that the memory page can be freed and reused to store new data. When the memory page corresponding to the data being stored in the storage device is to be accessed, the memory page previously swapped into the storage device can be swapped back from the storage device into the main memory by reading the data from the storage device. The data can be read into a memory page (e.g., the same memory page when it is not being in active use, or another memory page that is not in active used) to restore the state of the memory page. Accessing to the memory page can then be directed to the memory page having the state restored from the storage device.

The operations of swapping memory pages between the main memory and the storage device can cause significant overhead for the processing device of the computer system and cause significant latencies in memory access.

At least some aspects of the present disclosure address the above and other deficiencies and challenges by configuring memories of different characteristics (e.g., NAND flash memory and DRAM) in a same hybrid memory module to provide memory services in a unified way to a host system. A hardware-accelerated page migration engine is configured in the hybrid memory module to intelligently manage data movements across the memories of different characteristics within the memory module to reduce burdens on the host system and to reduce latencies.

For example, the hybrid memory module can be connected to the host system via a compute express link (CXL) connection such that the host system can access the memories of different characteristics (e.g., NAND flash memory and DRAM) using a same memory access protocol (e.g., CXL.mem with cache coherency). The hybrid memory module has an address translation logic configured to translate the memory address of a memory access request received over the CXL connection to a physical memory address in the hybrid module. When the hybrid memory module determines or predicts that the host system is to access a memory page that is currently mapped to a slower memory (e.g., NAND flash memory), the page migration engine can move data of the memory page within the memory module to implement the memory page using a faster memory (e.g., DRAM). Thus, subsequent memory accesses made by the host system to the memory page can have an improved performance level without instructions from the host system to control and/or perform the page migration. Since the hybrid memory module includes non-volatile memory (e.g., NAND flash), the hybrid memory module can also function as a persistent data storage device. The hybrid memory/storage module can be used to provide enhanced capacity accessible to a host system through the CXL.mem interface and a memory access protocol. Autonomous and intelligent page migration allows the hybrid memory module to offer efficient utilization of different media types or memory tiers (e.g., NAND flash memory and DRAM).

For example, the hybrid memory module can have an integrated, specialized hardware engine to perform autonomous page migration across different memory media with no intervention or minimal intervention from the host system. The hybrid memory module can have data buffer chip architecture to implement data movement, and to perform page migration with prediction capabilities. Autonomous and predictive page migration can reduce latencies, reduce host/controller overhead in media management, improve efficiency in utilization of media bandwidth, reduce power consumption, and/or maintain memory/cache coherency. For example, the hybrid memory module can be connected to a CXL fabric to provide or enlarge a secondary random access memory of a computer system by expanding upon the memory capacity of the main memory of the computer system.

Optionally, the hybrid memory module can include different types of media/memory tiers (e.g., NAND flash memory and DRAM), a control unit, a page migration engine, a page translation unit, and a queuing system.

The control unit can be implemented using dedicated hardware in a data management buffer chip. The control unit can control an interface to a CXL connection, and different media interfaces to memory chips of different types. For example, a double data rate (DDR) interface can be controlled by the control unit to operate on one or more DRAM memory chips; and an open NAND flash interface (ONFI) can be controlled by the control unit operate on one or more NAND memory chips. Optionally, the control unit can further include power and thermal sensing circuits to control the power usages and/or thermal states of the hybrid memory module.

The page migration engine can include one or more direct memory access (DMA) engines configured to operate on the memory chips via the media interfaces (e.g., DDR/ONFI interface). The page migration engine can have buffers of different page sizes optimizes for respective media (e.g., 4 KB/8 KB for DRAM memory and one or more MBs for NAND flash memory). The page migration engine can further include error detection and correction circuits to protect integrity of data to or from the media using error correction code (ECC) techniques.

The page translation unit can include hardware for memory address translation and caching capabilities for address translation tables. The page translation unit can manage page states of memory pages within the hybrid memory module.

The queuing system can enable priority-based migration queues along with logic to stitch pages together. The queuing system can manage dependencies of pages to be migrated and operate on the principles of quality of service (QoS).

In a typical sequence of operations, the memory module receives a memory access request through its CXL.mem interface. The control unit can determine, in response to the memory access request, whether to migrate a memory page and if so, send a migration request to the page migration engine with a priority assignment. For example, a memory page in a NAND flash memory chip being accessed via the memory access request can be migrated to a DRAM memory chip; and optionally, a memory page in a DRAM memory chip that is not likely to be used in a next period of time can be migrated to a NAND flash memory chip to free up resources in the DRAM memory chip. The page migration engine can perform a resource availability check, and perform address translation. To perform a page migration, a DMA transfer is initiated, and error handling performed. After data is delivered, the translation table is updated. After a status update, resources used in the page migration operation can be cleared and released for processing the next page migration request.

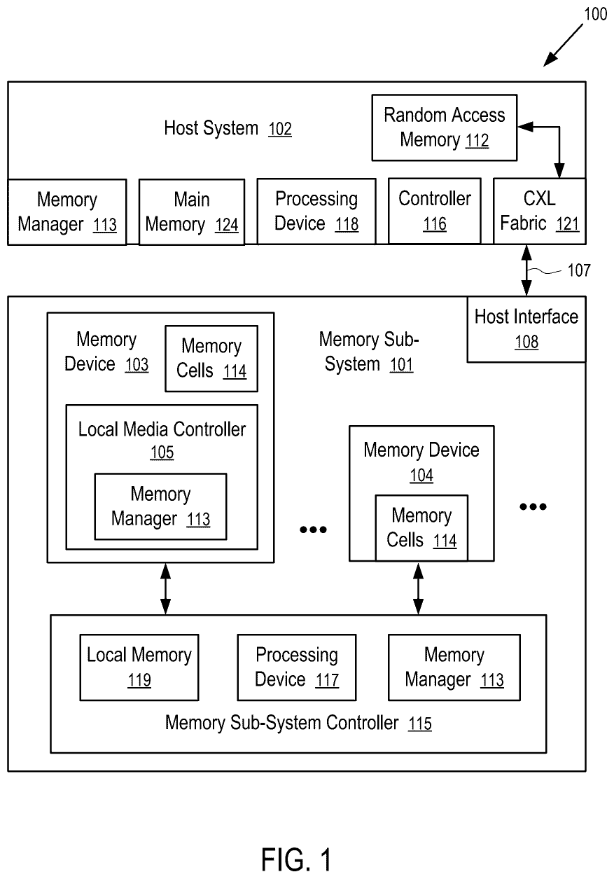

FIG. 1 illustrates an example computing system 100 that includes a memory sub-system 101 in accordance with some embodiments of the present disclosure. The memory sub-system 101 can include media, such as one or more volatile memory devices (e.g., memory device 104), one or more non-volatile memory devices (e.g., memory device 103), or a combination of such.

In general, a memory sub-system 101 can be a storage device, a memory module, or a hybrid of a storage device and memory module. Examples of a storage device include a solid-state drive (SSD), a flash drive, a universal serial bus (USB) flash drive, an embedded multi-media card (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 102 that is coupled to one or more memory sub-systems 101. FIG. 1 illustrates one example of a host system 102 coupled to one memory sub-system 101. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 102 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 102 uses the memory sub-system 101, for example, to write data to the memory sub-system 101 and read data from the memory sub-system 101.

The host system 102 can be coupled (e.g., over a computer bus 107) to the memory sub-system 101 via a physical host interface 108. Examples of a physical host interface 108 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface 108 can be used to transmit data between the host system 102 and the memory sub-system 101. The host system 102 can further utilize an NVM express (NVMe) interface to access components (e.g., memory devices 103) when the memory sub-system 101 is coupled with the host system 102 by the PCIe interface. The physical host interface 108 can provide an interface for passing control, address, data, and other signals between the memory sub-system 101 and the host system 102. FIG. 1 illustrates a memory sub-system 101 as an example. In general, the host system 102 can access multiple memory sub-systems via a same communication connection, multiple separate communication connections, and/or a combination of communication connections.

The processing device 118 of the host system 102 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 102 and the memory sub-system 101. In general, the controller 116 can send commands or requests to the memory sub-system 101 for desired access to memory devices 103, 104. The controller 116 can further include interface circuitry to communicate with the memory sub-system 101. The interface circuitry can convert responses received from the memory sub-system 101 into information for the host system 102.

The controller 116 of the host system 102 can communicate with the controller 115 of the memory sub-system 101 to perform operations such as reading data, writing data, or erasing data at the memory devices 103, 104 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 103, 104 can include any combination of the different types of non-volatile memory components and/or volatile memory components. The volatile memory devices (e.g., memory device 104) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103 can include one or more arrays of memory cells 114. One type of memory cells, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 103 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells 114 of the memory devices 103 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 103 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 103 to perform operations such as reading data, writing data, or erasing data at the memory devices 103 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 101, including handling communications between the memory sub-system 101 and the host system 102.

In some embodiments, the local memory 119 can include memory registers storing memory pointers, fetched data, etc. The local memory 119 can also include read-only memory (ROM) for storing micro-code. While the example memory sub-system 101 in FIG. 1 has been illustrated as including the controller 115, in another embodiment of the present disclosure, a memory sub-system 101 does not include a controller 115, and can instead rely upon external control (e.g., provided by an external host, or by a processor or controller separate from the memory sub-system).

In general, the controller 115 can receive commands or operations from the host system 102 and can convert the commands or operations into instructions or appropriate commands to achieve the desired access to the memory devices 103. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 103. The controller 115 can further include host interface circuitry to communicate with the host system 102 via the physical host interface 108. The host interface circuitry can convert the commands received from the host system into command instructions to access the memory devices 103 as well as convert responses associated with the memory devices 103 into information for the host system 102.

The memory sub-system 101 can also include additional circuitry or components that are not illustrated. In some embodiments, the memory sub-system 101 can include a cache or buffer (e.g., DRAM) and address circuitry (e.g., a row decoder and a column decoder) that can receive an address from the controller 115 and decode the address to access the memory devices 103.

In some embodiments, the memory devices 103 include local media controllers 105 that operate in conjunction with the memory sub-system controller 115 to execute operations on one or more memory cells of the memory devices 103. An external controller (e.g., memory sub-system controller 115) can externally manage the memory device 103 (e.g., perform media management operations on the memory device 103). In some embodiments, a memory device 103 is a managed memory device, which is a raw memory device combined with a local controller (e.g., local media controller 105) for media management within the same memory device package. An example of a managed memory device is a managed NAND (MNAND) device.

The controller 115 and/or a memory device 103 can include a memory manager 113 configured to perform operations related to the management of the secondary random access memory 112 attached to the processing device 118 of the host system 102 via a compute express link (CXL) fabric 121. In some embodiments, the controller 115 in the memory sub-system 101 includes at least a portion of the memory manager 113. In other embodiments, or in combination, the fabric 121, the controller 116 and/or the processing device 118 in the host system 102 can include at least a portion of the memory manager 113. For example, the fabric 121, the controller 115, the controller 116, and/or the processing device 118 can include logic circuitry implementing the memory manager 113. For example, the switches and/or controller of the fabric 121, the controller 115, or the processing device 118 (processor) of the host system 102, can be configured to execute instructions stored in memory for performing the operations of the memory manager 113 described herein. In some embodiments, the memory manager 113 is implemented in an integrated circuit chip disposed in the memory sub-system 101 or a controller of the fabric 121. In other embodiments, the memory manager 113 can be part of firmware of the memory sub-system 101, an operating system of the host system 102, a device driver, a set of agents running in CXL switches of the fabric 121, a part of a fabric manager running a controller of the CXL fabric 121, or an application, or any combination thereof.

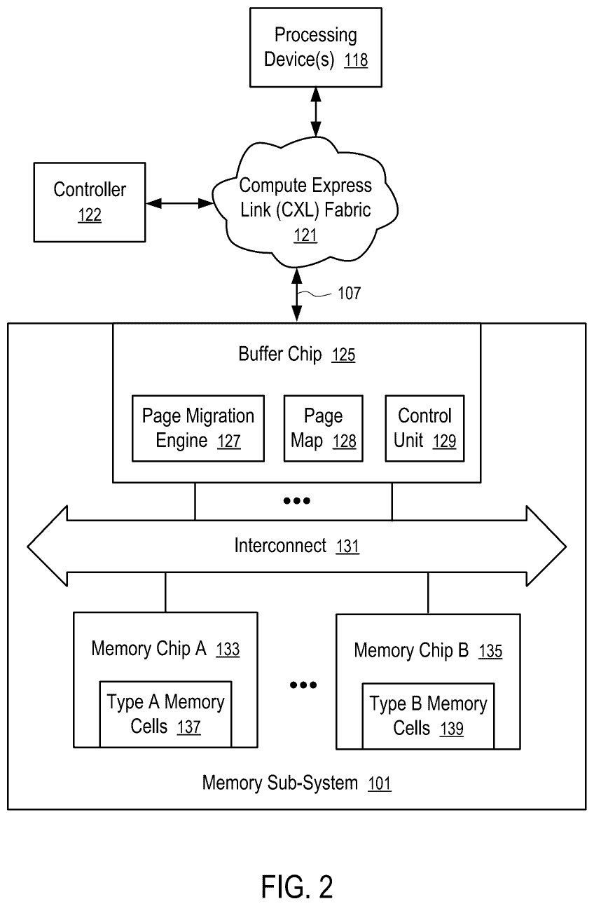

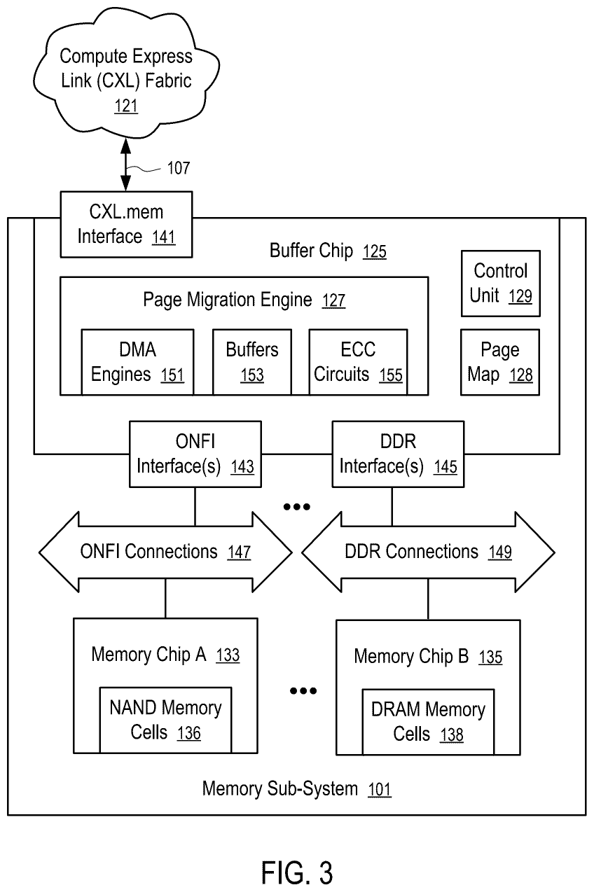

The random access memory 112 can be implemented using one or more memory devices attached to the CXL fabric 121 and/or the memory sub-system 101 to supplement the main memory 124. For example, the memory sub-system 101 can be configured with a page migration engine 127 as illustrated in, and further discussed below in connection with, FIG. 2 and FIG. 3.

FIG. 2 shows a memory sub-system having a page migration engine configured according to one embodiment. For example, the memory sub-system 101 of FIG. 1 can be implemented in a way as illustrated in FIG. 2 to provide at least a portion of the secondary random access memory 112 for the processing device(s) 118 in the host system 102.

In FIG. 2, the memory sub-system 101 includes a buffer chip 125 is configured as a gateway between memory chips 133, . . . , 135 in the memory sub-system 101 and a connection 107 to the memory sub-system 101.

For example, a processing device 118 can be connected to the memory sub-system 101 through the connection 107 with a compute express link (CXL) fabric 121. The compute express link fabric 121 can have one or more CXL switches controlled by a controller 122.

A conventional buffer chip is typically used in a server memory module to maintain signal integrity and to allow a higher number of dual in-line memory module (DIMM) slots per channel as well as support low-power applications. For example, a fully buffered DIMM (FB-DIMM) can have an advanced memory buffer (AMB) to compensate for signal deterioration by buffering and resending the signal.

The buffer chip 125 in the memory sub-system 101 can not only compensate for signal deterioration but also perform page migration operations to change how memory resources in the memory chips 133, . . . , 135 are used.

For example, a memory chip 133 can include memory cells 137 of a first type (e.g., NAND flash memory to offer increased capacity at a low cost and persistent storage capability). For example, a memory chip 135 can include memory cells 139 of a second type (e.g., DRAM to offer improved performance in latency, bandwidth, endurance).

The buffer chip 125 can include a page map 128 that determines where a memory page being accessed over the connection 107 is physically located. For example, during one period of operation of the memory sub-system 101, a memory address in a memory page addressed over the connection 107 can be in the memory chip 133; and during another period of operation of the memory sub-system 101, the memory page can be in the memory chip 135. The page migration engine 127 can perform page migration operations to change the page map to best utilize the memory resources in the memory chips 133, . . . , 135 of the memory sub-system 101.

The buffer chip 125 can include a page migration engine 127, and a control unit 129 configured to control the operations of page migration engine 127. After a page migration operation is submitted to the page migration engine 127, the page migration engine 127 can perform operations to migrate a page in the background without further assistance from the control unit 129.

For example, to move a memory page that is currently in the memory chip 135 to the memory chip 133, the page migration engine 127 can use a direct memory access (DMA) engine to store the data of the memory page in the source memory chip 133 to the destination memory chip 133 over the interconnect 131 among the buffer chip 125 and the memory chips 133, . . . , 135. Once the data of the memory page is in the destination memory chip 133, the page migration engine 127 and/or the control unit 129 can update the page map 128 to direct access to the memory page to the memory chip 133. Similarly, the page migration engine 127 can migrate a memory page from the memory chip 133 to the memory chip 135.

In some implementations, the memory sub-system 101 is configured to offer a memory capacity that is substantially equal to the sum of the capacities of the memory chips 133, . . . , 135. A portion of the non-volatile capacity of the memory chips 133, . . . , 135 (e.g., implemented via memory cells of a non-volatile type, such as NAND flash memory) can be reserved for the persistent storage of the page map 128. Optionally, a further portion of the non-volatile capacity of the memory chips 133, . . . , 135 can be reserved as free memory resources to facilitate page migration operations and/or to be used as replacement of bad/damaged memory pages or blocks.

In such implementations, the memory sub-system 101 can offer a memory capacity that includes a first portion that is volatile (e.g., implemented using memory cells of a volatile type, such as DRAM) and a second portion that is non-volatile (e.g., implemented via memory cells of a non-volatile type, such as NAND flash memory). Through page migration operations, some memory pages in the second, non-volatile portion can be migrated to a memory chip (e.g., 135) having volatile memory (e.g., to improve the performance level in accessing the memory pages). In response to an indication of a power outage event (or a command to shut down), the page migration engine 127 can migrate such pages back to a memory chip(s) (e.g., 133) having memory cells of the non-volatile type.

Alternatively, the sub-system 101 is configured to offer a memory capacity that is substantially equal to the sum of the capacities of the non-volatile memory chips (e.g., 133) in the memory sub-system 101. The volatile memory chips (e.g., 135) in the memory sub-system 101 are used by the control unit 129 to host actively used memory pages. For example, the control unit 129 can be configured to use the volatile memory chips (e.g., 135) as a cache memory to access the memory pages in the non-volatile memory chips (e.g., 133). In response to an indication of a power outage event (or a command to shut down), the page migration engine 127 can migrate such pages back to a memory chip(s) (e.g., 133) having memory cells of the non-volatile type. Thus, the entire capacity offered by the memory sub-system 101 can be considered non-volatile.

In some implementations, the control unit 129 can track the usages of memory pages hosted in a volatile memory chip (e.g., 135). When a memory page is not in active use for a period longer than a threshold, the control unit 129 can request the page migration engine 127 to migrate the page to a non-volatile memory chip (e.g., 133) to free up resources in the volatile memory chip (e.g., 135). Freeing up the resources can allow an actively used memory page to be migrated to the volatile memory chip (e.g., 135) or selectively powering down (or entering a low power mode) sections of the memory chip (e.g., 135) (or the entire memory chip 135) to reduce power consumption.

FIG. 3 shows an example of memory sub-systems having a page migration engine configured according to one embodiment. For example, the memory sub-system 101 of FIG. 1 and/or FIG. 2 can be implemented in a way as illustrated in FIG. 3 to provide at least a portion of the secondary random access memory 112 for the processing device(s) 118 in the host system 102.

In FIG. 3, the memory sub-system 101 has a single external-facing interface, such as a CXL.mem interface 141 operable on a connection 107 to a compute express link (CXL) fabric 121. The CXL.mem interface 141 can be configured to support memory access requests in compliance with a protocol standard of CXL.mem.

The control unit 129 of the buffer chip 125 is configured to generate memory access responses to requests received in the CXL.mem interface 141.

The buffer chip 125 can have a plurality of internal-facing interfaces to access the memory chips 133, . . . , 135 of different characteristics.

For example, a memory chip 133 has NAND memory cells 136 that can be access via an ONFI interface 143 over ONFI connections 147 provided within the memory sub-system 101.

For example, a memory chip 135 has DRAM memory cells 138 that can be access via a DDR interface 145 over DDR connections 149 provided within the memory sub-system 101.

The page migration engine 127 in FIG. 3 has a plurality of DMA engines 151 to transfer data between buffers 153 in the buffer chip 125 and memory chips 133, . . . , 135.

For example, the page migration engine 127 can have a DMA engine adapted to read data from and write data to a NAND memory chip (e.g., 133) using an ONFI interface 143, and a separate DMA engine adapted to read data from and write data to a DRAM memory chip (e.g., 135) using an ONFI interface 143.

The NAND memory cells 136 are generally less reliable than DRAM memory cells 138 in data storage and retrieval. The page migration engine 127 can include error correction code (ECC) circuits 155 to generate redundant information for writing data to the NAND memory chips (e.g., 133) and to decode the data with redundant information retrieved from the NAND memory chips (e.g., 133).

Optionally, the buffer chip 125 can also include ECC circuits 155 adapted to enhance data integrity for reading from and writing to DRAM memory chips (e.g., 135).

For example, different DMA engines 151 of the page migration engine 127 can be used in parallel to transfer data between the buffers 153 and the memory chips (e.g., 133 and 135) to perform page migration operations in the background while the control unit 129 is servicing memory access requests received in the CXL.mem interface 141 using other internal-facing interfaces to memory chips in the memory sub-system 101.

For example, in response to a memory access request received in the CXL.mem interface 141, the control unit 129 can determine from the page map 128 that the memory address identified in the memory access request is in a memory page currently hosted in the NAND memory chip 133. The control unit 129 can access the memory chip 133 to retrieve data from the NAND memory chip 133 into the buffers 153 to generate a response to the memory access request. The latency of retrieving the data from the NAND memory chip 133 is longer than retrieving the data from the DRAM memory chip 135. The control unit 129 can determine that further access to the memory page can occur in a next period of time; and in response, the control unit 129 can generate a request for the page migration engine 127 to migrate the memory page to the DRAM memory chip 135. The migration operation can be performed using at least in part the data in the buffers 153.

After the page migration request is dispatched to the page migration engine 127, the control unit 129 can further service subsequent memory access requests received in the CXL.mem interface 141.

Typically, a smallest unit of data (e.g., 512 bytes or 4 KB) that can be retrieved by the buffer chip 125 and error corrected using the ECC circuits 155 can be significantly larger than the size (e.g., one byte or 32 bytes, or 64 bytes, or 128 bytes) of the data requested by a memory access request received in the CXL.mem interface 141. Thus, one of the subsequent memory access requests can be directed to a portion of the data that is already in the buffer 153; and the control unit 129 can generate a response using the data in the buffer 153, while the page migration engine 127 migrates the memory page to the DRAM memory chip 133 in the background. The subsequent memory access requests can also include accesses to other memory pages (e.g., a page in the DRAM memory chip 135 or another memory chip in the memory sub-system 101).

After the completion of the migration of the memory page, the page migration engine 127 and/or the control unit 129 can update the page map 128. The buffer 153 storing the data for the memory page can be freed; and subsequent accesses to the memory page can be serviced via the control unit 129 access the DRAM memory chip 135 using a DDR interface 145.

When the control unit 129 determines that the memory page in the DDR memory chip 135 becomes cold (e.g., having not been accessed via the CXL.mem interface 141 for a period of time longer than a threshold), the control unit 129 can send a page migration request to the page migration engine 127 to migrate the memory page to a NAND memory chip 133.

When a section of the DRAM memory chip 135 has no valid data, the control unit 129 can instruct the DRAM memory chip 135 to place the section in a low power mode and/or shut down the section.

When the DRAM memory chip 135 has no valid data, the control unit 129 can instruct the DRAM memory chip 135 to enter a low power mode and/or to shut down.

Thus, the operations of the page migration engine 127 allows the control unit 129 to best utilize the resources of the memory chips 133, . . . , 135 for overall performance in capacity, latency, bandwidth, endurance, and data integrity, and to improve or optimize power usages of the memory sub-system 101.

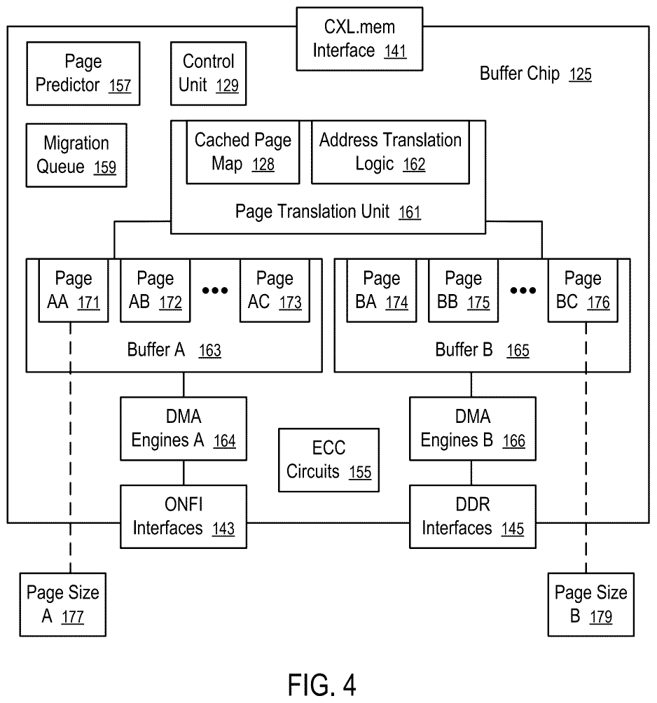

FIG. 4 shows a buffer chip configured with a page migration queue according to one embodiment. For example, the buffer chips 125 in FIG. 2 and FIG. 3 can be implemented in a way as illustrated in FIG. 4.

In FIG. 4, the buffer chip 125 includes one or more DMA engines 164 to access NAND memory chips (e.g., 133) via one or more ONFI interfaces using a protocol standard of ONFI (e.g., over ONFI connections 147). Further, the buffer chip 125 includes one or more DMA engines 166 to access DRAM memory chips (e.g., 135) via one or more DDR interfaces using a protocol standard for DDR memory bus (e.g., over DDR connections 149).

The buffer chip 125 has a buffer 163 configured to buffer data read from or to be written to NAND memory chips (e.g., 133). The buffer 163 has pages 171, 172, . . . , 173, each having a same page size 177 optimized for throughput and/or memory bandwidth accessing NAND memory chips (e.g., 133).

The buffer chip 125 has a buffer 165 configured to buffer data read from or to be written to DRAM memory chips (e.g., 135). The buffer 165 has pages 174, 175, . . . , 176, each having a same page size 179 optimized for throughput and/or memory bandwidth in accessing DRAM memory chips (e.g., 133).

The page size 179 (e.g., 4 KB or 8 KB) for DRAM access is smaller than the page size 177 (e.g., one GB or larger) for NAND access.

For example, a page (e.g., 171) for NAND access can contain multiple pages (e.g., 174, 175, . . . ) for DRAM access. To migrate memory pages from a DRAM memory chip (e.g., 135) to a NAND memory chip (e.g., 133), the buffer chip 125 can stitch multiple pages (e.g., 174, 175, . . . ) of DRAM data in a page (e.g., 171) for NAND access for a DMA engine 164 to write into a NAND memory chip (e.g., 133).

To protect integrity of data stored in a NAND memory chip (e.g., 133), the buffer chip 125 can use ECC circuits 155 to generate redundant information using an error correction code technique, such as low-density parity check (LDPC). When retrieving data from a NAND memory chip (e.g., 133), the buffer chip 125 can use the ECC circuit 155 to detect and correct random bit errors using the error correction code technique to recover error free data into the buffer 163.

After a page (e.g., 171) of data is retrieved from a NAND memory chip (e.g., 133), the buffer chip 125 can separate them into multiple pages (e.g., 174, 175, . . . ) of the size 179 for DRAM access. Optionally, the buffer chip 125 can migrate the set of pages (e.g., 174, 175, . . . ) corresponding to the entire page (e.g., 171) of NAND data into one or more DRAM memory chips (e.g., 135). Alternatively, the buffer chip 125 can migrate a subset of the pages of the size 179, selected from the page (e.g., 171) of NAND data for migration into one or more DRAM memory chips (e.g., 135).

The buffer chip 125 has a page translation unit 161 having an address translation logic 162 and a cached page map 128. A memory page as known to the external world outside of the CXL.mem interface 141 can be mapped to a page in a DRAM memory chip (e.g., 135), a portion of a page in a NAND memory chip (e.g., 133), or a page in a buffer (e.g., 163, 165) while the migration of the page is in progress. The control unit 129 can use the address translation logic 162 to translate, using the cached page map 128, the memory address identified in a memory access request received in the CXL.mem interface 141 and service the request using a buffer (e.g., 163 or 165) a memory chip (e.g., 133 or 135) as identified by the result of the address translation.

The buffer chip 125 in FIG. 4 includes a page predictor 157 configured to identify, based on activities of memory access requests received in the CXL.mem interface 141, candidate pages for page migration.

For example, when one or more memory access requests received in the CXL.mem interface 141 address a memory page currently hosted in a NAND memory chip (e.g., 133) and/or having data buffered in the buffer 163, the page predictor 157 can predict that more subsequent memory access requests will be directed to the memory page. In response, the page predictor 157 can enter into a migration queue 159 a request to migrate the memory page to a DRAM memory chip (e.g., 135).

For example, when the memory access requests received in the CXL.mem interface 141 has a sequential pattern of access and is expected to access a page that is currently hosted in a memory chip (e.g., 133) having a lower performance level than another memory chip (e.g., 135), the page predictor 157 can add a page migration request to the queue 159 to preemptively migrate the page to the faster memory chip (e.g., 135). When the migration completes before a memory access request addressing the memory page is received in the CXL.mem interface 141, a response to the memory access request can be provided with a shorter latency than generating the response using the slower memory chip (e.g., 133).

For example, when one or more memory pages in a DRAM memory chip (e.g., 135) have not been accessed via the CXL.mem interface 141 for a period longer than a threshold, the page predictor 157 can predict that further memory access requests received subsequently in the CXL.mem interface 141 are not likely to address the one or more memory pages. In response, the page predictor 157 can enter into a migration queue 159 a request to migrate the one or more memory pages to a NAND memory chip (e.g., 133) for persistent storage, reduced power consumption in the DRAM memory chip (e.g., 135), and/or freed memory resources that can be used to host another memory page for active use.

The buffer chip 125 can prioritize the requests in the migration queue 159 to schedule their execution for improve performance. For example, when a page is predicted to be accessed in a next period of time, the priority of the request can be set to be high to maximize the performance in responding to requests to access the page. For example, when the free memory resources in a DRAM memory chip (e.g., 135) is low, the requests to migrate pages from the DRAM memory chip (e.g., 135) can be assigned a high priority to allow memory pages to be migrated into the DRAM memory chip (e.g., 135). Thus, the buffer chip 125 can execute the requests in the queue 159 based on the priorities of the requests in the queue and thus out of the order in which the requests are entered into the queue 159.

In some instances, the priorities of page migration requests are assigned based at least in part on the quality of service (QoS) identified in memory requests in the CXL.mem interface 141. For example, the CXL.mem interface 141 can receive two interleaved sequences of memory access requests that are predicted to access two separate memory pages hosted in a NAND memory chip 133. The page predictor 157 can enter requests to migrate the two pages with priority levels assigned according to QoS indicators provided sequences of memory access requests such that the migration of a page predicted to be accessed by memory access requests with a high QoS indicator is assigned a high priority level, and the migration of a page predicted to be access by memory access request with a low QoS indicator is assigned a low priority level.

In some instances, the buffer chip 125 can aggregate multiple requests for migration from one or more DRAM memory chip (e.g., 135) to generate a page of the size 177 for migration into a NAND memory chip (e.g., 133) as one request.

In some instances, the buffer chip 125 can separate a request for migration of NAND data in a page (e.g., 171) in the buffer into a plurality of requests for migrating from pages (e.g., 174, 175, . . . ) for different DRAM memory chips (e.g., 135).

In some implementations, the buffers 163 and 165 are configured in one or more DRAM memory chips (e.g., 135) that have a higher level of performance and/or endurance than a NAND memory chip (e.g., 133).

FIG. 2 to FIG. 4 are discussed and/or illustrated using a NAND memory chip (e.g., 133) as an example of non-volatile memory chip. Other types of non-volatile memory chips can also be used, such as a NOR flash memory chip, a cross-point memory chip. Similarly, FIG. 2 to FIG. 4 are discussed and/or illustrated using a DRAM memory chip (e.g., 135) as an example of volatile memory chip. Other types of volatile memory chips can also be used, such as an SRAM memory chip. Thus, the implementation of a memory sub-system 101 is not limited to the use of NAND memory chips (e.g., 133) and DRAM memory chips (e.g., 135).

FIG. 2 to FIG. 4 are discussed and/or illustrated using an ONFI interface (e.g., 143) as an example for accessing a NAND memory chip (e.g., 133). Alternatively, an embedded multi media card (eMMC) interface can be used.

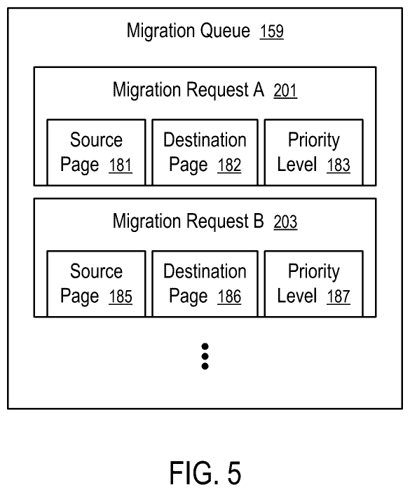

FIG. 5 illustrates a page migration queue according to one embodiment. For example, the migration queue 159 in the buffer chip 125 of FIG. 4 can be implemented in a way as illustrated in FIG. 5.

In FIG. 5, the migration queue 159 can have a plurality of slots, each configured to hold one migration request (e.g., 201 or 203).

A migration request (e.g., 201 or 203) can have a field configured to identify a source page (e.g., 181 or 185), a field configured to identify a destination page (e.g., 182 or 186), and a field configured to identify a priority level (e.g., 183 or 187) of the request (e.g., 201 or 203).

A source page (e.g., 181) can have an address in a buffer (e.g., 163 or 165), or in a memory chip (e.g., 133 or 135). A destination page (e.g., 182) can also have an address in a buffer (e.g., 163 or 165), or in a memory chip (e.g., 135 or 133). The DMA engines (e.g., 151; 164, 166) of the page migration engine 127 can transfer data between buffers 163, 165, and between buffers 153 and memory chips (e.g., 133, 135) according to the requests in the migration queue 159 and their priority levels.

For example, a memory page in a NAND memory chip can be migrated to a page (e.g., 171) in the buffer 163. The page 171 in the buffer 163 can be separated for migration into multiple pages (e.g., 174, 175, . . . ) in the buffer 165. The pages (e.g., 174, 175) in the buffer 165 can be migrated separately to one or more DRAM memory chips (e.g., 135).

Similarly, memory pages in one or more DRAM memory chips (e.g., 135) can be migrated to pages (e.g., 174, 175, . . . ) in the buffer 165. Multiple pages (e.g., 174, 175, . . . ) in the buffer 165 can be stitched together in a page 171 for further migration to a NAND memory chip (e.g., 133).

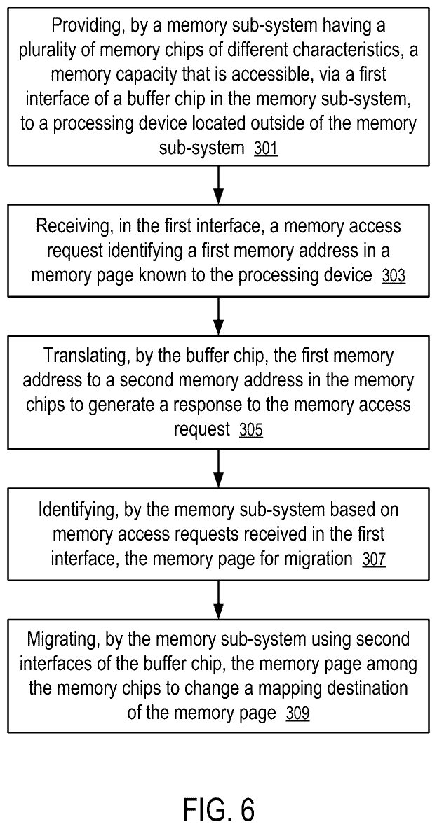

FIG. 6 shows a method of autonomous page migration within a heterogeneous memory sub-system according to one embodiment. The method of FIG. 6 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 6 is performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 6 can be implemented (e.g., via software, firmware and application specific circuits) as part of a memory manager 113 in the memory sub-system 101 and/or the host system 102.

For example, the memory sub-system 101 includes: a plurality of memory chips 133, . . . , 135 of different characteristics (e.g., in volatile or not, latency, bandwidth, throughput, endurance, energy consumption); and a buffer chip 125 coupled to the memory chips 133, . . . , 135. For example, each of the memory chips 133, . . . , 135 and the buffer chip 125 is a separate integrated circuit device having its own integrated circuit package. The memory sub-system 101 includes a printed circuit board having traces connected to pins of the integrated circuit devices.

For example, the buffer chip 125 includes: a first interface (e.g., 141) configured to allow a processing device 118 outside of the memory sub-system 101 to access a memory capacity of the memory sub-system 101 implemented using the memory chips 133, . . . , 135; a plurality of second interfaces (e.g., 143, 145) to the memory chips 133, . . . , 135; and a page migration engine 127 operable to migrate, among the memory chips 133, . . . , 135, a memory page as known to the processing device 118.

For example, the first interface (e.g., 141) is operable on a compute express link (CXL) connection to receive memory access requests in a CXL.mem protocol; and the second interfaces (e.g., 143, 145) can include a double data rate (DDR) interface, an open NAND flash interface (ONFI), or an embedded multi media card (eMMC) interface, or any combination thereof.

For example, the memory sub-system 101 and/or the page migration engine 127 can include a first buffer 163 having first pages 171, 172, . . . , 173 each having a first size 177 to buffer data read from or to be written to a subset of the memory chips (e.g., 133) via the open NAND flash interface (ONFI) 143. The memory sub-system 101 and/or the page migration engine 127 can further include a second buffer 165 having second pages 174, 175, . . . , 176 each having a second size 179, smaller than the first size 177, to buffer data read from or to be written to a subset of the memory chips (e.g., 135) via the double data rate (DDR) interface 145.

For example, the memory sub-system 101 and/or the page migration engine 127 can include a plurality of direct memory access (DMA) engines (e.g., 151; 164, 166) operable to access the memory chips 133, . . . , 135 through the second interfaces (e.g., 143, 145).

For example, the memory sub-system 101 and/or the page migration engine 127 can include error correction code (ECC) circuits 155 operable to generate redundant information for data written through the ONFI interface 143 and to decode data read through the ONFI interface 143.

For example, the memory sub-system 101 and/or the page migration engine 127 can include an address translation logic configured to translate a memory address received in the first interface (e.g., 141) into an address (e.g., unknown to the processing device 118) in the memory chips 133, . . . , 135 or in one of the first buffer 163 and the second buffer 165.

For example, the memory sub-system 101 and/or the page migration engine 127 can include a migration queue 159 and be operable to process page migration requests (e.g., 201, 203) in the migration queue 159 according to priority levels (e.g., 183, 187) specified for the page migration requests (e.g., 201, 203) in the queue 159. Instead of processing the requests (e.g., 201, 203) in the order of being entered into the migration queue 159, the memory sub-system 101 and/or the page migration engine 127 can take a request out of order from the queue 159 based at least in part on the priority levels (e.g., 183, 187) of the page migration requests (e.g., 201, 203).

For example, the memory sub-system 101 and/or the page migration engine 127 can include a page predictor 157 configured to generate the page migration requests (e.g., 201, 203) in response to memory access requests received in the first interface (e.g., 141).

At block 301, the method of FIG. 6 includes providing, by a memory sub-system 101 having a plurality of memory chips 133, . . . , 135 of different characteristics, a memory capacity that is accessible, via a first interface 141 of a buffer chip 125 in the memory sub-system 101, to a processing device 118 located outside of the memory sub-system 101.

For example, the first interface (e.g., 141) is operable on a compute express link (CXL) connection (e.g., to a CXL fabric 121); and the second interfaces (e.g., 143, 145) include a double data rate (DDR) interface 145, an ONFI interface 143, an embedded multi media card (eMMC) interface, or any combination thereof.

At block 303, the method includes receiving, in the first interface 141, a memory access request identifying a first memory address in a memory page known to the processing device 118.

At block 305, the method includes translating, by the buffer chip 125, the first memory address to a second memory address (e.g., unknown to the processing device 118) in the memory chips 133, . . . , 135 to generate a response to the memory access request.

At block 307, the method includes identifying, by the memory sub-system 101 based on memory access requests received in the first interface 141, the memory page for migration.

At block 309, the method includes migrating, by the memory sub-system 101 using second interfaces (e.g., 143, 145) of the buffer chip 125, the memory page among the memory chips 133, . . . , 135 to change a mapping destination of the memory page.

For example, the method of FIG. 6 can further include: buffering, in a first buffer 163 having first pages 171, 172, . . . , 173 each having a first size 177, data read from or to be written to a first subset of the memory chips (e.g., 133); and buffering, in a second buffer 165 having second pages 174, 175, . . . , 176 each having a second size 179, smaller than the first size 177, data read from or to be written to a second subset of the memory chips (e.g., 135).

For example, the buffer chip 125 can include a plurality of direct memory access (DMA) engines 151, including a first subset (e.g., DMA engines 164) configured to use the first buffer 163 and a second subset (e.g., DMA engines 166) configured to use the second buffer 165. The DMA engines 151 are each configured to perform the transfer of one page (e.g., 171 or 174) from a buffer (e.g., 163 or 165) to or from a memory chip (e.g., 133 or 135) at a time. The sizes 177 and 179 are optimized for performance in such transfers to respective memory chips (e.g., 133 or 135).

For example, the method of FIG. 6 can further include: generating, using error correction code (ECC) circuits 155 in the buffer chip 125, redundant information for data written to the memory chips (e.g., 133) via the first buffer (e.g., 163); and decoding, using the error correction code (ECC) circuits 155, data read from the memory chips (e.g., 133) into the first buffer 163.

For example, the method of FIG. 6 can further include: generating, in a migration queue 159, a plurality of page migration requests (e.g., 201, 203) to migrate memory pages among the memory chips (e.g., 133, 135); and determining an order to execute the page migration requests (e.g., 201, 203) in the migration queue 159 based on priority levels (e.g., 183, 187) of the page migration requests (e.g., 201, 203).

For example, the method of FIG. 6 can further include: combining a plurality of page migration requests of migrating a plurality of pages (e.g., 174, 175, . . . ) from the second subset of the memory chips (e.g., 135) into a page migration request of migrating to a page (e.g., 171) in the first subset of the memory chips (e.g., 133).

For example, the method of FIG. 6 can further include: generating a plurality of page migration requests of migrating a plurality of pages (e.g., 174, 175, . . . ) to the second subset of the memory chips (e.g., 135) to implement a page migration request of migrating to a page (e.g., 171) in the first subset of the memory chips (e.g., 133).

In at least some embodiments, the memory sub-system 101 is configured to migrate pages across the memory chips 133, . . . , 135 based on migration requests (e.g., 201, 203) identified by the memory sub-system 101 using a reinforcement learning technique.

In general, access to memory pages hosted in a slower memory chip (e.g., 133 with NAND memory cells 136) can be improved through caching the memory pages in buffers (e.g., 153; 163) and/or in faster memory chip (e.g., 135 with DRAM memory cells 138). However, traditional caching systems lack the ability to predict future access patterns, to optimize for multiple concurrent workloads, and/or to dynamically adjust their caching policies according to changing application requirements.

The memory sub-system 101 can be configured with intelligent caching capabilities to learn, and evolve with, application behaviors while maintaining/improving performance and efficiency.

For example, a caching engine driven by artificial intelligence (AI) can be configured in the memory sub-system 101 to identify memory pages for predictive caching in, and/or for migration to, a faster memory chip (e.g., 135 with DRAM memory cells 138) from a slower memory chip (e.g., 133 with NAND memory cells 136), before the memory pages are accessed by the host system 102.

For example, a technique of reinforcement learning and continuous learning can be implemented in the memory sub-system 101 to improve the predictive capability of the memory sub-system 101 in identifying memory pages for migration by the page migration engine 127. The memory sub-system 101 can use neural networks to perform access pattern prediction, use reinforcement learning for cache policy optimization, and use online learning for continuous adaptation to workload changes. The memory sub-system 101 can maintain a feedback loop for ongoing optimization while ensuring protocol compliance and meeting performance targets.

The intelligent capabilities of the memory sub-system 101 can improve hit rates through AI driven prediction, reduce latency through predictive prefetching/page migration, optimize resource utilization through learned cache/page migration policies, while providing autonomous adaptation to changing workload patterns and maintaining compatibility with host software control.

For example, the hit rate can be a percentage of, among memory access requests received in the CXL.memory interface 141 over the connection 107, a portion of requests that address memory pages being hosted in faster memory chips (e.g., 135) at the time of the requests. Since servicing the memory access requests addressing the memory pages hosted in the faster memory chips (e.g., 135) has a lower latency level than servicing the memory access requests addressing the memory pages hosted in the slower memory chips (e.g., 133), increasing the hit rate can improve the overall latency performance of the memory sub-system 101 in servicing the host system 102.

For example, the memory sub-system 101 can have a neural processing unit configured with dedicated hardware for neural network inference and training, including pattern recognition circuits, prediction engines, and reinforcement learning accelerators with performance counters. The use of the neural processing unit in the memory sub-system 101 can accelerate the computations of AI driven predictions and/or page migration decisions.

For example, the memory sub-system 101 can have a continuous learning engine configured with hardware that implements online learning techniques, maintains historical pattern datasets, and updates prediction models in real-time with specialized tensor processing units.

For example, the memory sub-system 101 can have a reinforcement learning module configured to manage reward calculations, policy updates, and action selection based on observed memory access performance and system state, with dedicated circuits configured to implement a reinforcement learning technique (e.g., Q-learning).

For example, the memory sub-system 101 can have an adaptive policy controller configured with hardware to dynamically adjust caching/page migration strategies, prefetching policies, and resource allocation based on AI predictions and learned behaviors with real-time monitoring capabilities.

For example, the neural network configured in the memory sub-system 101 processes incoming memory access patterns and workload characteristics. The reinforcement learning module in the memory sub-system selects optimal caching/page migration actions based on current state and learned policies. Caching/page migration decisions are executed while the memory sub-system 101 monitors performance metrics and reward signals. The continuous learning module in the memory sub-system 101 updates models based on observed performance and reward outcomes and new patterns. The memory sub-system 101 periodically updates policy networks to incorporate newly learned optimization. The memory sub-system 101 can continuously operate in this loop, constantly learning and adapting to achieve optimal performance for the current workload mix. The AI models can become increasingly sophisticated over time as they learn from more diverse workload patterns and scenarios.

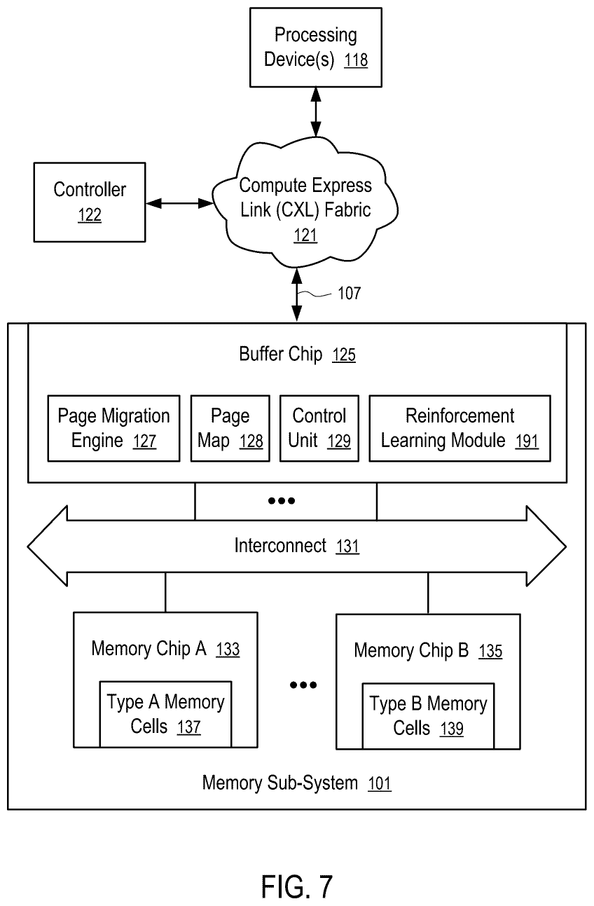

FIG. 7 shows a memory sub-system having a reinforcement learning module configured to identify pages for migration according to one embodiment. For example, a memory sub-system 101 in FIG. 1 to FIG. 3 can be configured to further include a reinforcement learning module 191 as in FIG. 7.

In FIG. 7, a reinforcement learning module 191 is configured in a buffer chip 125 of the memory sub-system 101 to identify memory pages for migration within the memory sub-system 101 for improved performance of the memory sub-system 101 (e.g., in the latency of the memory sub-system 101 in responding to memory access requests from the host system 102).

For example, the reinforcement learning module 191 can consider a memory page currently being hosted, according to the page map 128, in a faster memory chip (e.g., 135) as a cached page of the memory page hosted in a slower memory chip (e.g., 133). Since the memory page is cached in the faster memory chip (e.g., 135), the latency of the host system 102 accessing the memory page decreases (and thus the latency performance of the memory sub-system 101 increases), when the arrangement is compared to the memory page being hosted in the slower memory chip (e.g., 133) without being cached.

However, when the memory page is cached in the faster memory chip (e.g., 135) for an extended period without being accessed by the host system 102, the memory resources of the faster memory chip (e.g., 135) are seen inadequately used, especially when there are other memory pages that can be cached to improve the overall latency performance of the memory sub-system 101.

In general, the memory sub-system 101 can host memory pages in the memory chips (e.g., 133, . . . , 135) without establishing the relation that a memory page being hosted in a faster memory chip (e.g., 135) is a cached page of the memory page being hosted in a slower memory chip (e.g., 133). For example, when a memory page is hosted in a faster memory chip (e.g., 135), the memory sub-system 101 may not allocate a page from a slower memory chip (e.g., 133) for the same memory page.

When a memory page is hosted in a faster memory chip (e.g., 135) and the host system 102 accesses the memory page, the latency performance of the memory sub-system 101 in responding to the memory access request can be optimal; and thus, a positive reward can be provided to the reinforcement learning module 191 for its decision to keep the memory page hosted in the faster memory chip (e.g., 135).

However, when the memory page is hosted in a faster memory chip (e.g., 135) for a time period and the host system 102 does not access the memory page during the time period, the memory resources in the faster memory chip (e.g., 135) to host the memory page are not utilized in an optimal way, especially when there are memory pages that are being accessed during the time period but cannot be hosted in the faster memory chip (e.g., 135) due to the lack of free memory resources in the memory chip (e.g., 135). In such a situation, the reinforcement learning module 191 can be provided with a negative reward (or penalty) for its decision to keep the memory page hosted in the faster memory chip (e.g., 135).

When a memory page is hosted in a slower memory chip (e.g., 133) and the host system 102 accesses the memory page, the latency performance of the memory sub-system 101 in responding to the memory access request can be non-optimal; and thus, a negative reward (or penalty) can be provided to the reinforcement learning module 191 for its decision to keep the memory page hosted in the slower memory chip (e.g., 133).

However, when the memory page is hosted in a slower memory chip (e.g., 133) for a time period and the host system 102 does not access the memory page during the time period, hosting the memory page in the slower memory chip can free up memory resources from a faster memory chip (e.g., 135). Thus, the usages of memory resource in the slower memory chip (e.g., 135) to host the memory page is optimal; and a positive reward can be provided to the reinforcement learning module 191 for its decision to keep the memory page hosted in the slower memory chip (e.g., 133).

The reinforcement learning module 191 can include a reward model configured to predict the reward/penalty that it can receive for making a decision to migrate, or not migrate, a memory page. For example, when the memory page is currently hosted in a slower memory chip 133, the reinforcement learning module 191 can predict the reward/penalty that it can receive for migrating the memory page to a faster memory chip 135 (or buffers 153), and to predict the reward/penalty that it can receive for keeping the memory page hosted in the slower memory chip 133. For example, when the memory page is currently hosted in a faster memory chip 135, the reinforcement learning module 191 can predict the reward/penalty that it can receive for migrating the memory page to a slower memory chip 133, and to predict the reward/penalty that it can receive for keeping the memory page hosted in the faster memory chip 135. The reinforcement learning module 191 can decide to migrate the memory page if the reward model predicts that the reward for migrating the memory page is larger than the reward for not migrating the memory page; and the reinforcement learning module 191 can decide not to migrate the memory page if the reward model predicts that the reward for not migrating the memory page is larger than the reward for migrating the memory page.

Since the rewards/penalties are configured based on performance impacts of the decisions, maximizing rewards can improve the overall performance of the memory sub-system 101.

In some instances, the rewards predicted by the reward model can be inaccurate; and the page migration decisions made by the reinforcement learning module 191 can be sub-optimal. The memory sub-system 101 can determine the actual rewards for the page migration decisions made by the reinforcement learning module 191 to further train the reward model to improve its prediction capability and/or accuracy. Thus, over a period of time, the reward model can converge; and the page migration decisions made by the reinforcement learning module 191 can be become optimized.

In some implementations, the memory sub-system 101 is configured to group, based on memory access activities/patterns of the host system 102 during a last time period of a predetermined length, memory pages. The reinforcement learning module 191 make migration decisions for memory page groups, instead of making decision on a per memory page basis.

For example, memory pages having the same type of hosting configuration can be classified within a same group based on similarity in their predicted usage patterns during a next period of time. The reinforcement learning module 191 can be configured to make a migration decision for the entire group, instead of making separate decisions of individual memory pages.

Optionally, the memory sub-system 101 can collect data about the accuracy of classifying the memory pages into a same group based on actual memory access activities that occur after the predictions made to classify the memory pages. When some memory pages are actually accessed during a next time period in a pattern that is different from what is predicted by a neural model, the memory sub-system 101 can generate training data to further train the neural model to improve its accuracy in predicting the access patterns for grouping of memory pages.

If the reinforcement learning module 191 decides, based on the memory access activities of the host system 102, to migrate a memory page currently hosted in a slower memory chip (e.g., 133), the reinforcement learning module 191 can enter a page migration request (e.g., 201) in the migration queue 159; and in response, the page migration engine 127 can migrate the memory page from the slower memory chip (e.g., 133) to a faster memory chip (e.g., 135) (or to the buffers 153).

If the reinforcement learning module 191 decides, based on the memory access activities of the host system 102, to migrate a memory page from a faster memory chip (e.g., 135), the reinforcement learning module 191 can enter a page migration request (e.g., 203) in the migration queue 159; and in response, the page migration engine 127 can migrate the memory page from the faster memory chip (e.g., 135) to the slower memory chip (e.g., 133).

Optionally, the memory sub-system 101 can allocate a portion of the faster memory cells (e.g., 139) in one or more faster memory chips (e.g., 135) as a cache memory; and the reinforcement learning module 191 can implement the caching, in the cache memory, of memory pages that are hosted in slower memory cells (e.g., 137). Optionally, the buffers 153 can be allocated as the cache memory, or part of the cache memory.

Based on the page migration requests identified by the reinforcement learning module 191, the page migration engine 127 can move the data of the memory page among the memory chips (e.g., 133, 135), the cache memory, and/or the buffers (e.g., 153).

In some implementations, the memory sub-system 101 is configured to allocate a portion of the capacity of faster memory (e.g., DRAM memory cells 138 and/or a portion of DRAM or SRAM in the buffer chip 125) as a cache memory. The reinforcement learning module 191 is configured to request the page migration engine 127 to migrate a memory page to or from the cache memory.

Alternatively, the reinforcement learning module 191 can treat entire capacity of the faster memory (e.g., DRAM and/or SRAM in the memory sub-system 101) as a cache memory for memory pages hosted in slower memory (e.g., NAND in the memory sub-system 101) in deciding caching or cache eviction, even though there is no formal caching relation in the memory sub-system 101 for the memory pages. For example, when a memory page is hosted in the faster memory (e.g., DRAM and/or SRAM in the memory sub-system 101), there can be no arrangement of the memory page being also hosted in the slower memory (e.g., NAND in the memory sub-system 101) where the page in the faster memory is the cached version of the page in the slower memory. When the memory page is hosted in the faster memory, the memory sub-system 101 does not store data to indicate the hosting of the memory page in a slower memory and does not allocate a page from the slower memory for the memory page. When the reinforcement learning module 191 decides to cache a memory page currently being hosted in the slower memory, the page migration engine 127 can migrate the hosting of the memory page in the slower memory to the faster memory; and when the reinforcement learning module 191 decides to evict a memory page from the faster memory, the page migration engine 127 can migrate the hosting of the memory page in the faster memory to the slower memory.

For example, when the reinforcement learning module 191 predicts that, at the current state of operation of the memory sub-system 101, the reinforcement learning module 191 is to receive more reward to migrate a memory page than not migrating the memory page, the reinforcement learning module 191 can decide to migrate the memory page and enter a migration request for the memory page in the migration queue 159. If the memory page is currently hosted in a slower memory chip (e.g., 133), the page migration engine 127 can migrate the memory page to a faster memory chip (e.g., 135); and if the memory page is currently hosted in a faster memory chip (e.g., 133), the page migration engine 127 can migrate the memory page to a slower memory chip (e.g., 135). After the page migration, the memory sub-system 101 can determine a reward or penalty for the page migration decision based on the timing of the host system 102 in accessing the memory page.

For example, if the memory page is migrated from the slower memory chip (e.g., 133) to the faster memory chip (e.g., 135), a predetermined maximum reward can be provided to the reinforcement learning module 191 when the memory page is accessed by the host system 102 immediately after the page migration. The reward can be reduced (e.g., linearly over time) and extended to a penalty when the time gap between the memory access and the page migration increases.

For example, if the memory page is migrated from the faster memory chip (e.g., 135) to the slower memory chip (e.g., 133), a predetermined maximum reward can be provided to the reinforcement learning module 191 when the memory page is accessed by the host system 102 at a predetermined time period after the page migration. The reward can be reduced (e.g., linearly over time) and extended to a penalty when the time gap between the memory access and the page migration increases or decreases.

The memory sub-system 101 is configured to provide reward/penalty to the reinforcement learning module 191 not only for a memory page identified by the reinforcement learning module 191 for migration, but also for a memory page identified by the reinforcement learning module 191 for no migration.

For example, if the reinforcement learning module 191 decides to keep a memory page being hosted in a faster memory chip (e.g., 135), a predetermined maximum reward can be provided to the reinforcement learning module 191 when the memory page is accessed by the host system 102 immediately after the decision of no page migration for the memory page. The reward can be reduced (e.g., linearly over time) and extended to a penalty when the time gap between the memory access and the page migration increases.

For example, if the reinforcement learning module 191 decides to keep a memory page being hosted in a slower memory chip (e.g., 133), a predetermined maximum reward can be provided to the reinforcement learning module 191 when the memory page is accessed by the host system 102 at least a predetermined time period after the decision of no migration. The reward can be reduced (e.g., linearly over time) and extended to a penalty when the time gap between the memory access and the page migration decreases.

In some embodiments, the reinforcement learning module 191 is configured to identify source pages for migration; and the page migration engine 127 is configured to identify the destinations of the page migration based on resource availability, and/or efficiency in data movements.

For example, the pages in a faster memory chip (e.g., 135) can have a page size 179 that is smaller than pages in a slower memory chip (e.g., 133). The page migration engine 127 can combine multiple pages to be migrated from one or more faster memory chips (e.g., 135) for migration into a page in a slower memory chip (e.g., 133). Optionally, the page migration engine 127 can initially migrate the pages in the faster memory chips (e.g., 135) to a page (e.g., 171) having the larger page size 177 in the buffer 163; and subsequently, the data in the larger page (e.g., 171) can be migrated to a slower memory chip (e.g., 133).

For example, the pages in a slower memory chip (e.g., 133) can have a page size 177 that is larger than pages in a faster memory chip (e.g., 133). The page migration engine 127 can separate a large page in a slower memory chip (e.g., 133) into multiple pages of the smaller page size 179 for hosting in one or more faster memory chips (e.g., 135). Optionally, the page migration engine 127 can initially migrate the data from the page in the slower memory chip (e.g., 133) to a page (e.g., 171) having the larger page size 177 in the buffer 163; and subsequently, the data in the larger page (e.g., 171) can be migrated to one or more faster memory chips (e.g., 135) and/or the buffer 165.

Since the page migration engine 127 can identify migration destinations for pages identified by the reinforcement learning module 191, the reinforcement learning module 191 can skip identifying the destinations for the page migration requests entered into the migration queue 159.

The reinforcement learning module 191 is configured to make decisions in migrating or not memory pages based on rewards/penalties it can receive for the decisions based on the predictions of its reward model. The actual rewards calculated and provided to the reinforcement learning module 191 to train its reward model for adaptation to changing patterns of the workload of the memory sub-system 101.

In some implementations, the reward model is implemented via an artificial neural network model; and during a period of exploration and training, the reinforcement learning module 191 can make various decisions (e.g., randomly) related to page migration to learn the actual rewards/penalties received and to train the reward model. After the accuracy of the reward model improves and/or converges, the reinforcement learning module 191 can make page migration decisions based on maximizing its rewards.

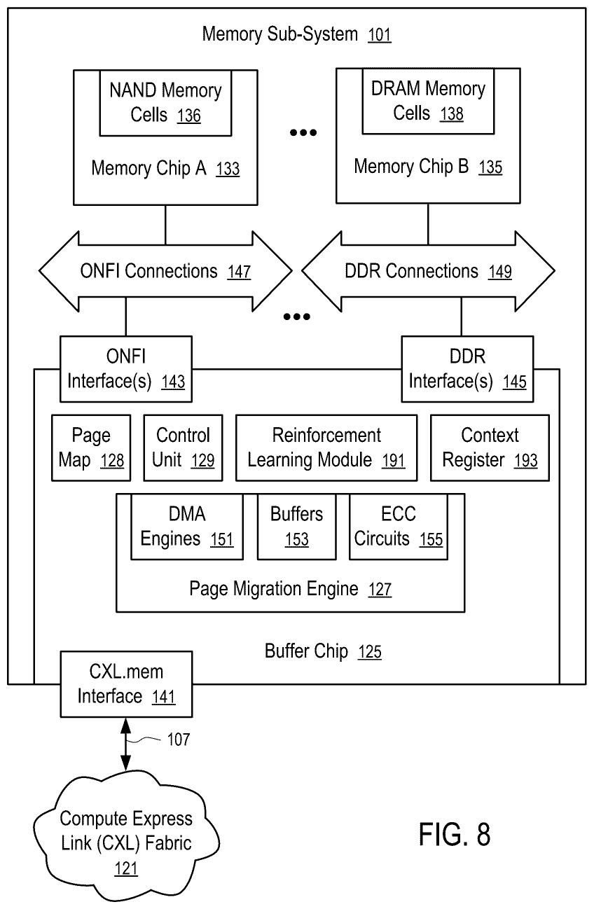

FIG. 8 shows an example of memory sub-systems having a reinforcement learning module and a page migration engine configured according to one embodiment. For example, a memory sub-system 101 in FIG. 1 to FIG. 3 and FIG. 7 can be configured to include a reinforcement learning module 191 with a context register 193 as in FIG. 8.

In FIG. 8, the reinforcement learning module 191 is controlled by the content in the context registers 193 in the memory sub-system 101. A host system 102 can change the behavior of the reinforcement learning module 191 by writing hints, context data, and/or rules in the context register 193 to influence or control the page migration decisions of the reinforcement learning module 191.

For example, the context registers 193 have a predetermined memory address known to the host system 102. When the host system 102 stores data to the memory address over the connection 107 using a memory access protocol, the data is stored into the context register 193 to control the reinforcement learning module 191.

For example, the context register 193 can include data specifying how rewards and/or penalties are calculated for the reinforcement learning module 191.

For example, the time gap between a decision to migrate a memory page from a faster memory chip (e.g., 135) and a subsequent request from the host system 102 to access memory page for providing a maximum reward for page migration decision can be tuned or customized by the data specified in the context register 193.

For example, the time gap between a decision to keep a memory page in a faster memory chip (e.g., 135) and a subsequent request from the host system 102 to access memory page for reducing a reward associated with the decision to zero can be tuned or customized by the data specified in the context register 193.

For example, the time gap between a decision to migrate a memory page from a slower memory chip (e.g., 133) and a subsequent request from the host system 102 to access memory page for reducing a reward associated with the decision to zero can be tuned or customized by the data specified in the context register 193.

For example, the time gap between a decision to keep a memory page in a slower memory chip (e.g., 135) and a subsequent request from the host system 102 to access memory page for a maximum reward associated with the decision can be tuned or customized by the data specified in the context register 193.

Optionally, the host system 102 can use the context register 193 to identify memory pages that are to be hosted in faster memory chips (e.g., 135); and the memory sub-system 101 is configured to avoid generating page migration requests for such memory pages.

Optionally, the host system 102 can use the context register 193 to identify memory pages that are to be hosted in slower memory chips (e.g., 133); and the memory sub-system 101 is configured to avoid generating page migration requests for such memory pages.

Optionally, the host system 102 can use the context register 193 to identify a characteristic of a memory access workload of the memory sub-system 101; and the reinforcement learning module 191 is configured to predict rewards based on the characteristic. For example, the characteristic can include the context of running one or more applications that cause the memory access workload for the memory sub-system 101.

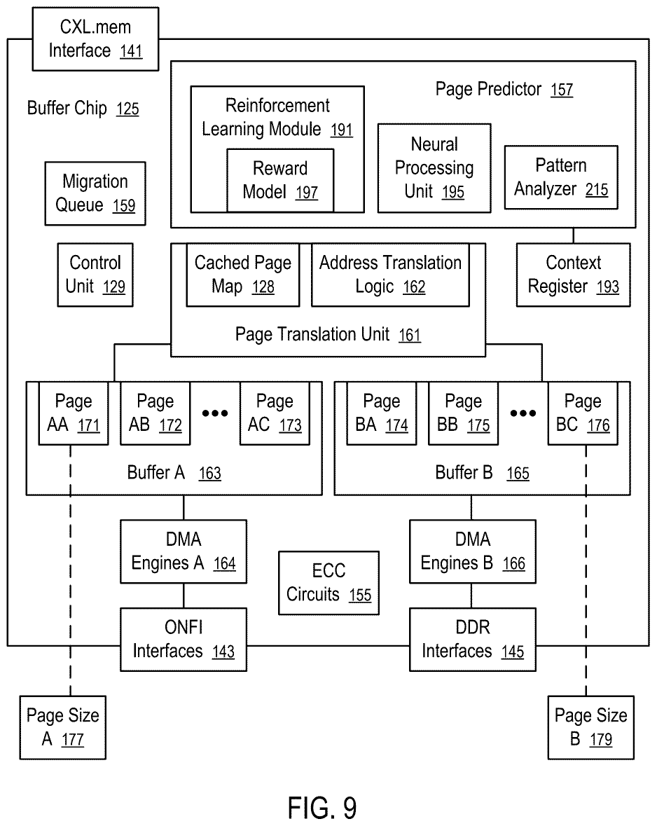

FIG. 9 shows a buffer chip configured with a reinforcement learning module having a reward model to identify memory pages for migration according to one embodiment. For example, the buffer chip 125 in FIG. 7 and FIG. 8 can be implemented in a way as illustrated in FIG. 9 and/or FIG. 4.

In FIG. 9, a page predictor 157 is configured in the buffer chip 125 to identify memory pages for migration. The page predictor 157 includes a reinforcement learning module 191, a neural processing unit 195, and a pattern analyzer 215. The reinforcement learning module 191 includes a reward model 197 used to predict a reward/penalty for the reinforcement learning module 191 making a decision about page migration, such as keeping a memory page hosted in a memory chip (e.g., 133 or 135), or migrating the memory page off the memory chip (e.g., 133 or 135).

The neural processing unit 195 can include a multiplier-accumulator unit (MAC unit) to accelerate computations involved in the reward model 197 and/or the pattern analyzer 215.

The page predictor 157 is configured to identify a state of the memory sub-system 101 in which the buffer chip 125 is installed. The state is configured to be represented a set of state parameters relevant to the decision of whether to migrate a memory page (or a group of memory pages classified by the pattern analyzer 215 to be in a similar situation for page migration).

For example, the set of state parameters can include parameters in the context register 193. Further, the set of state parameters can include parameters indicative of the availability of free resources in the buffers 163 and 165 and/or in one or more faster memory chips (e.g., 135) accessible via the DDR interfaces 145. The set state parameters can classify the memory pages in the page map 128 into a plurality of groups based on their similarity in being accessed by the host system 102 over the CXL.mem interface 141 in a prior time period and/or their probability of being accessed in a next time period of a predetermined length.

The reward model 197 is configured and trained to predict the reward to the reinforcement learning module 191 for selecting a page migration decision for a group of memory pages at the state represented by the state parameters. For example, the reward model 197 can include an artificial neural network to receive the state parameters as an input and to provide a prediction of the reward for migrate the memory pages in the group, to keep the memory pages in place without migration, and/or to migrate a percentage of the memory pages in the group. Based on the predicted rewards for the different decisions, the reinforcement learning module 191 can select a decision that is expected to lead to the largest the reward.

Based on the page migration decisions for the different memory page groups, the page predictor 157 can generate page migration requests (e.g., 201, 203) in a migration queue 159 (e.g., as in FIG. 5). The DMA engines 164 and 166 can be used to implement the page migration requested in the migration queue 159.

The page predictor 157 can further monitor the memory access activities following the migration decisions selected according to the reward model 197 to calculate the actual rewards. The actual rewards can be different from the rewards predicted by the reward model 197. The page predictor 157 can further train the reward model 197 based on the actual rewards calculated according to the memory access activities in the time period following the migration decisions.

Similarly, the pattern analyzer 215 can monitor the memory access activities to determine the memory page classifications for grouping and/or memory access patterns during the next period of time. A neural module of the pattern analyzer 215 can also be trained to reduce the differences between the memory page classifications for group and/or memory access patterns as predicted during the migration decisions and as measured during the next period of time.

After a period of exploration and training, the reward model 197 can lead the page predictor 157 to make optimal migration decisions to maximize rewards, which corresponds to optimizing the memory service performance of the memory sub-system 101 containing the buffer chip 125.

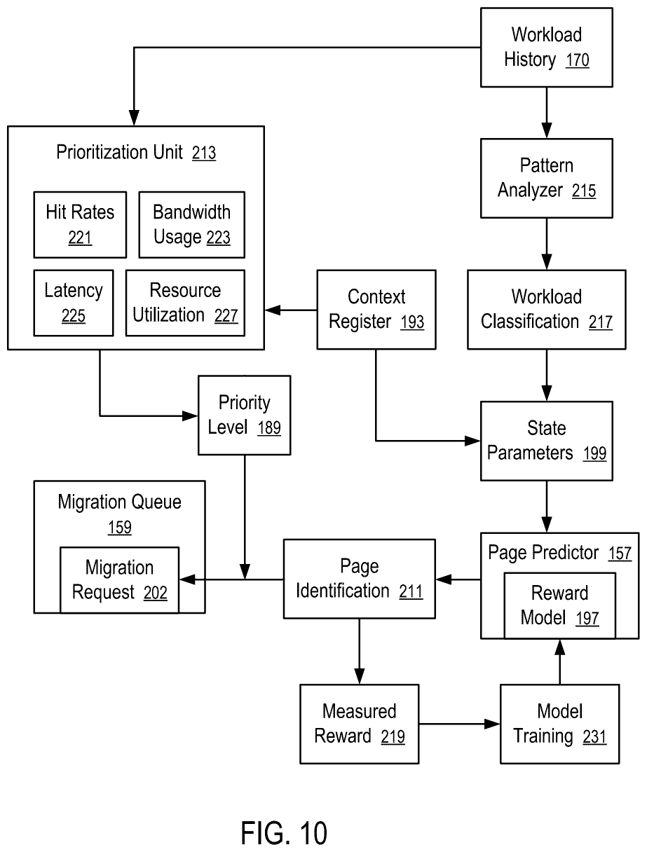

FIG. 10 illustrates a technique to identify pages for migration using a reinforcement learning module according to one embodiment. For example, the technique of FIG. 10 can be implemented in the memory sub-system 101 of FIG. 7 and FIG. 8 using the buffer chip 125 of FIG. 7 to FIG. 9.

In FIG. 10, a pattern analyzer 215 configured in the memory sub-system 101 determines a workload classification 217 from a history 170 of the workload of the memory sub-system 101 in handling the memory access requests received in the memory sub-system 101 over a connection 107 to the host system 102.

For example, the workload classification 217 can be based on, and/or include parameters quantifying spatial/temporal locality, stride patterns, or other characteristics in the memory access requests in the history 170.

For example, the workload classification 217 can include the classifications of memory pages in the page map 128 into a plurality of groups, wherein memory pages in a same group have similar memory access patterns for page migration.

The parameters specified by the host system 102 in the context register 193 and the parameters in the workload classification 217 can from a set of state parameters 199 identifying a state for the page predictor 157 to make page migration decisions.

The page predictor 157 is configured to use a reward model 197 to make page migration decisions. For example, the page predictor 157 can use the reward model 197 to predict a first reward for migrating the pages in a group, a second reward for not migrating the pages in the group, a third reward for migrating a predetermined percentage of pages in the group, etc. The page predictor 157 is configured to select the page migration decision that corresponds to the largest one of the first reward, the second reward, the third reward, etc.

Based on the page migration decisions made using the reward model 197, the page predictor 157 can determine the page identification 211 of each memory page to be migrated by the page migration engine 127.

A prioritization unit 213 can monitor the workload history 170 to identify the performance of the memory sub-system 101, such as hit rates 221, usage 223 of memory bandwidth of memory chips 133, . . . , 135, latency 225 of the memory chips 133, . . . , 135 in responding to memory access requests, and utilization 227 of fast memory resources (e.g., DRAM memory cells 139). Based on the monitoring of the performance of the memory sub-system 101, the prioritization unit 213 of the memory sub-system 101 can assign a priority level 189 to the page identified by the reinforcement learning module 191 for migration; and a migration request 202 can be generated in the migration queue 159 with the priority level 189 for the migration of a page having the identification 211 determined using the reward model 197.

In a time period following the page migration decisions, the memory sub-system 101 can monitor the memory activities of the host system 102 to measure rewards 219 for the page migration decisions made using the rewards predicted by the reward model 197. The measured rewards 219 can be different from the predicted rewards. Model training 231 can be performed to improve the accuracy of the reward model 197 in predicting the rewards, adapt the reward model 197 to the changing context as represented by the parameters in the context register 193 and/or adapt the reward model 197 to the changing patterns in the workload history 170.

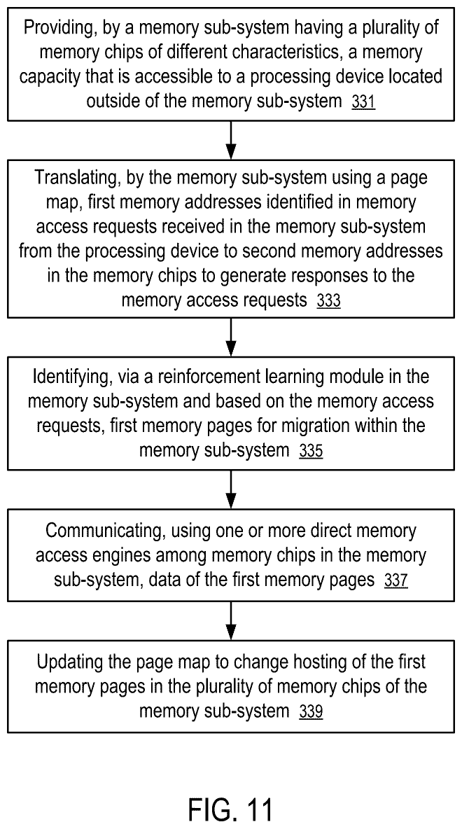

FIG. 11 shows a method of page migration within a heterogeneous memory sub-system according to one embodiment. The method of FIG. 11 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 11 is performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 11 can be implemented (e.g., via software, firmware and application specific circuits) as part of a memory manager 113 in the memory sub-system 101 and/or the host system 102.

For example, the computing system 100 can include: a host system 102 having a processing device 118 and a main memory 124; a memory sub-system 101; and a compute express link (CXL) fabric 121 connected between the host system 102 and the memory sub-system 101. The memory sub-system includes: at least one first memory chip (e.g., 133) having memory cells (e.g., 136) of a first type (e.g., NAND or NOR flash memory); at least one second memory chip having memory cells (e.g., 138) of a second type (e.g., DRAM or SRAM); a reinforcement learning module 191; and a page migration engine 127. The reinforcement learning module 191 is configured to identify, based on a reward model 197, memory pages for migration between the at least one first memory chip (e.g., 133) and the at least one second memory chip (e.g., 135); and the page migration engine 127 is configured to implement migration of the memory pages identified by the reinforcement learning module 191. Optionally, the memory sub-system 101 further includes a pattern analyzer 215 configured with an artificial neural network to determine a classification 217 of a workload of the memory sub-system 101; and an input to the reward model 197 includes the classification 217.

For example, the memory sub-system 101 can include a plurality of memory chips 133, . . . , 135 of different characteristics (e.g., in latency, bandwidth, throughput, volatile vs. non-volatile, memory cell type). The page migration engine 127 in the memory sub-system 101 is configured to migrate memory pages within the memory sub-system 101 in response to page migration requests (e.g., presented in a migration queue 159); and the reinforcement learning module 191 in the memory sub-system 101 is configured to identify the memory pages for migration based on the reward model 197 and memory access requests received in the memory sub-system 101 from a host system 102.

Optionally, the memory sub-system 101 includes a context register 193 configured to control operations of the reinforcement learning module 191. The context register 193 is programmable by the host system 102 outside of the memory sub-system 101 via writing data to a predefined memory address. For example, the memory sub-system 101 has a CXL.mem interface 141. The context register 193 is programmable via memory access requests identifying the predefined memory address and sent to the CXL.mem interface 141 via a connection 107 between the host system 102 and the memory sub-system 101.

Optionally, the memory sub-system 101 includes a neural processing unit 195 configured to accelerate computations of artificial neural networks. For example, the neural processing unit 195 can include a multiplier-accumulator (MAC) unit; and the reward model 197 and/or the pattern analyzer 215 can have an artificial neural network.

For example, the pattern analyzer 215 can be configured to determine a workload classification 217 based on a history 170 of the memory access requests received in the CXL.mem interface 141 from the host system 102 prior to the reinforcement learning module 191 identifying the memory pages for migration. The pattern analyzer 215 can include an artificial neural network configured to receive, as an input, data identifying the memory access requests to output the workload classification 217.

For example, the workload classification 217 can include classification of memory pages (e.g., as identified in the page map 128) into a plurality of groups based on similarity in memory access patterns in the memory access requests.

For example, the reward model 197 is configured to predict a reward for the reinforcement learning module 191 to select, in response to an input identify a set of state parameters 199 representative of a state of operation of the memory sub-system 101, an option of page migration for a group of memory pages. For example, the option can be for migrating the group of memory pages away from the memory chips currently hosting the respective memory pages, or keeping the group of memory pages in place being hosted in the memory chips currently hosting the respective memory pages, or migrating a percentage of the group of memory pages. For example, the percentage can be selected from a plurality of predefined percentages as options (e.g., zero, one hundred percent, or another predefined percentage).

Optionally, the set of state parameters 199 can include first parameters retrieved from the context register 193, and second parameters from the workload classification 217.

Optionally, the memory sub-system 101 includes an integrated circuit die having a field programmable gate array (FPGA) or an application specific integrated circuit (ASIC) configured to implement the reinforcement learning module 191, the neural processing unit 195, and the pattern analyzer 215. An integrated circuit package can be configured to enclose at least the integrated circuit die, and the page migration engine 127 (e.g., as a buffer chip 125).

At block 331, the method of FIG. 11 includes providing, by a memory sub-system 101 having a plurality of memory chips 133, . . . , 135 of different characteristics (e.g., in latency, bandwidth, throughput, volatile vs. non-volatile, memory cell type/technology), a memory capacity that is accessible to a processing device 118 located outside of the memory sub-system 101.

At block 333, the method includes translating, by the memory sub-system 101 using a page map 128, first memory addresses identified in memory access requests received in the memory sub-system 101 from the processing device 118 to second memory addresses in the memory chips 133, . . . , 135 to generate responses to the memory access requests.

At block 335, the method includes identifying, via a reinforcement learning module 191 in the memory sub-system 101 and based on the memory access requests, first memory pages for migration within the memory sub-system 101.

At block 337, the method includes communicating, using one or more direct memory access engines (e.g., 151; 164, 166) among memory chips 133, . . . , 135 in the memory sub-system 101, data of the first memory pages.

At block 339, the method includes updating the page map 128 to change hosting of the first memory pages in the plurality of memory chips 133, . . . , 135 of the memory sub-system 101.

Optionally, the method of FIG. 11 can further include: receiving, in the memory sub-system 101 and from the processing device 118, a request to store context data at a predefined address; and storing the context data into a context register 193 in the memory sub-system 101. The identifying of the first memory pages at block 335 can be based at least in part on the context data retrieved from the context register 193.

For example, the identifying of the first memory pages at block 335 can include: predicting, using a reward model 197 of the reinforcement learning module 191, a first reward for deciding to migrate the first memory pages; and predicting, using the reward model 197 of the reinforcement learning module 191, a second reward for deciding not to migrate the first memory pages. The first memory pages are identified for migration based on the first reward being larger than the second reward according to the predictions of the reward model 197.

Optionally, the method of FIG. 11 can further include: analyzing, by the memory sub-system 101, a memory access workload (e.g., workload history 170) of the memory sub-system 101 to determine a workload classification 217. The first reward and the second reward can be predicted by the reward model 197 using the workload classification 217 as at least a portion of inputs to the reward model 197.

Optionally, the method of FIG. 11 can further include: monitoring memory access requests addressing the first memory pages following the identifying of the first memory pages for migration at block 335; and calculating actual rewards (e.g., measured reward 219) for the identifying of the first memory pages for migration based on the monitoring.

Optionally, the method of FIG. 11 can further include: training 231 the reward model 197 using the actual rewards (e.g., reward 219) calculated based on the monitoring.

Optionally, the workload classification 217 includes a predicted memory access pattern related to the first memory pages; and the method of FIG. 11 further includes: determining an actual memory access pattern related to the first memory pages based on memory access activities addressing the first memory pages in a time period following the identifying of the first memory pages for migration at block 335; and training a pattern analyzer 215 to reduce a difference between the predicted memory access pattern and the actual memory access pattern.

A non-transitory computer storage medium can be used to store instructions programmed to implement a memory manager 113 configured to perform operations discussed above in connection with the memory sub-system 101. When the instructions are executed by the processing device (e.g., 117, 118), and/or the controller (e.g., 115, 122) the instructions cause the computing system 100 to perform the methods discussed above.

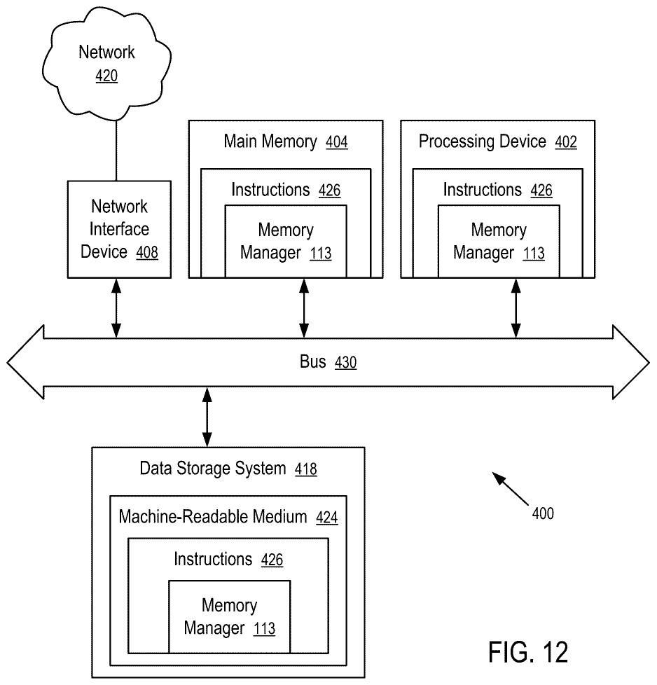

FIG. 12 illustrates an example machine of a computer system 400 within which a set of instructions, for causing the machine to perform any one or more of the methodologies discussed herein, can be executed. In some embodiments, the computer system 400 can correspond to a host system (e.g., the host system 102 of FIG. 1) that includes, is coupled to, or utilizes a memory sub-system (e.g., the memory sub-system 101 of FIG. 1) or can be used to perform the operations of memory managers 113 (e.g., to execute instructions to perform operations corresponding to the memory managers 113 described with reference to FIG. 1-11). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 101 of FIG. 1.

In one embodiment, the instructions 426 include instructions to implement functionality corresponding to the memory managers 113 described with reference to FIG. 1-11. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A memory sub-system, comprising:
a plurality of memory chips of different characteristics;
a page migration engine configured to migrate memory pages within the memory sub-system in response to page migration requests.

2. The memory sub-system of claim 1, further comprising:
a reinforcement learning module configured to identify the memory pages for migration based on a reward model and memory access requests received in the memory sub-system from a host system; and
a context register configured to control operations of the reinforcement learning module;
wherein the context register is programmable by the host system outside of the memory sub-system via writing data to a predefined memory address.

3. The memory sub-system of claim 2, further comprising:
a compute express link (CXL) interface, wherein the context register is programmable via memory access requests identifying the predefined memory address and sent to the compute express link (CXL) interface via a connection between the host system and the memory sub-system.

4. The memory sub-system of claim 2, wherein the plurality of memory chips include a NAND flash memory chip and a DRAM memory chip.

5. The memory sub-system of claim 4, further comprising:
a neural processing unit configured to accelerate computations of artificial neural networks;
wherein the reward model includes a first artificial neural network.

6. The memory sub-system of claim 5, further comprising:
a pattern analyzer configured to determine a workload classification based on a history of the memory access requests received prior to the reinforcement learning module identifying the memory pages for migration;
wherein the pattern analyzer includes a second artificial neural network configured to receive, as an input, data identifying the memory access requests.

7. The memory sub-system of claim 6, wherein the workload classification includes classification of memory pages into a plurality of groups based on similarity in memory access patterns in the memory access requests.

8. The memory sub-system of claim 7, wherein the reward model is configured to predict, in response to an input identifying a set of state parameters representative of a state of operation of the memory sub-system, a reward to select an option of page migration for a group of memory pages.

9. The memory sub-system of claim 8, wherein the set of state parameters include first parameters retrieved from the context register, and second parameters from the workload classification.

10. The memory sub-system of claim 9, further comprising:
an integrated circuit die having a field programmable gate array (FPGA) or an application specific integrated circuit (ASIC) configured to implement the reinforcement learning module, the neural processing unit, and the pattern analyzer; and
an integrated circuit package configured to enclose at least the integrated circuit die, and the page migration engine.

11. A method, comprising:
providing, by a memory sub-system having a plurality of memory chips of different characteristics, a memory capacity that is accessible to a processing device located outside of the memory sub-system;
translating, by the memory sub-system using a page map, first memory addresses identified in memory access requests received in the memory sub-system from the processing device to second memory addresses in the memory chips to generate responses to the memory access requests; and
identifying, via a reinforcement learning module in the memory sub-system and based on the memory access requests, first memory pages for migration within the memory sub-system.

12. The method of claim 11, further comprising:
communicating, using one or more direct memory access engines among memory chips in the memory sub-system, data of the first memory pages;
updating the page map to change hosting of the first memory pages in the plurality of memory chips of the memory sub-system;
receiving, in the memory sub-system and from the processing device, a request to store context data at a predefined address; and
storing the context data into a context register in the memory sub-system;
wherein the identifying of the first memory pages is based at least in part on the context data retrieved from the context register.

13. The method of claim 12, wherein the identifying of the first memory pages comprises:
predicting, using a reward model of the reinforcement learning module, a first reward for deciding to migrate the first memory pages; and
predicting, using the reward model of the reinforcement learning module, a second reward for deciding not to migrate the first memory pages;
wherein the first memory pages are identified for migration based on the first reward being larger than the second reward.

14. The method of claim 13, further comprising:
analyzing, by the memory sub-system, a memory access workload of the memory sub-system to determine a workload classification;
wherein the first reward and the second reward are predicted by the reward model using the workload classification as at least a portion of inputs to the reward model.

15. The method of claim 14, further comprising:
monitoring memory access requests addressing the first memory pages following the identifying of the first memory pages for migration; and
calculating actual rewards for the identifying of the first memory pages based on the monitoring.

16. The method of claim 15, further comprising:
training the reward model using the actual rewards calculated based on the monitoring.

17. The method of claim 16, wherein the workload classification includes a predicted memory access pattern related to the first memory pages; and the method further comprises:
determining an actual memory access pattern related to the first memory pages based on memory access activities addressing the first memory pages in a time period following the identifying of the first memory pages; and
training a pattern analyzer to reduce a difference between the predicted memory access pattern and the actual memory access pattern.

18. A computing system, comprising:
a host system having a processing device and a main memory;
a memory sub-system; and
a compute express link (CXL) fabric connected between the host system and the memory sub-system;
wherein the memory sub-system includes:
at least one first memory chip having memory cells of a first type;
at least one second memory chip having memory cells of a second type;
a reinforcement learning module; and
a page migration engine.

19. The computing system of claim 18, wherein the reinforcement learning module is configured to identify, based on a reward model, memory pages for migration between the at least one first memory chip and the at least one second memory chip;
wherein the page migration engine is configured to implement migration of the memory pages identified by the reinforcement learning module; and
wherein the memory sub-system further includes a pattern analyzer configured with an artificial neural network to determine a classification of a workload of the memory sub-system; and an input to the reward model includes the classification.

20. The computing system of claim 18, wherein the first type is flash memory; and the second type is dynamic random access memory (DRAM).
